(19) United States
(12) Patent Application Publication
(10) Pub. No.: US 2003/0163873 A1
(43) Pub. Date: Sep. 4, 2003

(54) Impact-absorbing unit

(76) Inventors: Christopher George Price, Gloucestershire (GB); Michael John Stephens, Gloucestershire (GB); Peter Anthony Bell, Herefordshire (GB)

Correspondence Address: DARBY & DARBY P.C., P. O. BOX 5257, NEW YORK, NY, 10150-5257, US

(21) Appl. No.: 10/257,428

(22) PCT Filed: Sep. 26, 2001
(86) PCT No.: PCT/GB01/04305

(30) Foreign Application Priority Data
Oct. 3, 2000 (GB) 0024170.3

(51) Int. Cl. E04G 21/32; A62B 1/22; A47C 27/00

(52) U.S. Cl. 5/657; 5/420; 5/722

(57) ABSTRACT

In one embodiment the invention provides an impact-absorbing unit comprising an outer wear-resistant casing (10) and one or a plurality of inner stress resistant envelopes (20) containing impact absorbing material. The outer envelope is provided with a plurality of interconnection means (65, 70) on at least one surface thereof, whereby a plurality of such units can be connected together in a closely adjacent relationship to define a substantially continuous surface. In another embodimentthe compressible elements are directly enclosed within the casing (10).In another embodiment the loose fill of compressible elements is replaced by at least one open cell foam element and valve means are provided for evacuating air from the foam, whereby to compress the foam and allow subsequent expansion thereof by exposure to ambient air pressure.

The present invention relates generally to an impact-absorbing unit and particularly to such a unit intended to prevent injury of individuals or damage to articles resulting from a fall.

The present invention finds particular, although not exclusive, utility on building construction sites. Recent legislation introduced for the construction industry demands that it must be ensured that an individual cannot fall more than two metres onto a hard surface. As the height of a construction increases scaffolding is used on the exterior; however, there is no method of preventing injury in the interior of the building. For example, whilst individuals are working on roofing timbers they can potentially fall into the interior of the building and land on what will probably be joists which will carry the floorboards of the uppermost level of the construction. The distance between the roofing timbers and the joists will be greater than two metres such that there is a need for some method of preventing injuries from such a fall, and indeed any situation where it is likely that an individual may fall from a distance greater than two metres onto a hard surface.

According to an aspect of the present invention there is provided an impact-absorbing unit comprising an outer wear-resistant casing and one or a plurality of inner stress resistant envelopes containing impact absorbing material, the outer envelope being provided with interconnection means associated with at least one surface thereof whereby a plurality of such units can be connected together in a closely adjacent relationship to define a substantially continuous surface.

Particularly where such units are used in the interior of a construction the dimensions are an important consideration. In general, constructions are made using materials having sets of standard dimensions; these are usually multiples of a third of a metre. Preferably therefore the dimensions of the unit will be slightly greater than the standard dimension to which it will be applied and therefore, because of its compressibility, will fit tightly in place.

Any suitable material can be used to fill the inner envelopes although a loose fill of substantially compressible particles is preferred, for example expanded polystyrene. In some embodiments the particles can interlock at least to some extent; most of an impact is absorbed by the compressibility of the material, although some is absorbed by particles moving apart. The impact-absorbing material is preferably such as to dissipate impact energy to avoid articles bouncing off.

The fill density of impact-absorbing material may be in the region of 1.85 to 1.90 kg per 0.425 cubic metres of inner envelope.

The or each inner envelope may be perforated to allow the passage of air therethrough. Where perforations are present in the inner envelope there is no particular shape or configuration necessary. In one embodiment 6 mm diameter circular holes are used with a density of 36 holes per metre squared.

The interconnection means may comprise a clasp or the like. In some embodiments the interconnection means comprise or include a strap. The interconnection means may be arranged to allow interconnection of adjacent upper and lower surfaces of respective units whereby to allow stacking of units to increase the absorbent capacity of the said substantially continuous surface.

Whilst in theory any size of unit may be created it is preferable for each unit to be easily portable and for interconnection means to be provided on each unit to allow interconnection with other such units to form a safe landing surface in which adjacent units abut edge to edge.

The unit may further comprise a handle portion. The clasps or the like may be positioned at the free ends of external straps secured to the outer casing at each end to form handles.

The present invention also provides an impact-absorbing unit comprising an outer wear-resistant casing, a closed inner stress resistant envelope containing a plurality of compressible elements loosely enclosed within it, the said outer wear-resistant casing comprising a plurality of substantially planar flexible panels secured together in such a way as to maintain an external form having at least one substantially flat surface to allow a plurality of such units to be placed adjacent one another with the said at least one surfaces of each unit lying substantially in a common plane whereby to define an overall surface for receiving falling objects.

The selection of materials for and the form of such a protection system is of particular importance if it is to function as required. For example, if used on a building construction site the unit will likely be subjected to a large amount of wear and tear. The unit may be required to absorb impacts indefinitely and so preferably retains a predetermined shape.

In a preferred embodiment the unit is of generally parallelepiped form. Such a unit may be formed from two major panels each defining two adjacent major surfaces of the parallelepiped and two rectangular end panels. The panels may be secured edge to edge to form a projecting ridge; the panels may be secured together by stitching. The thread used for stitching of the outer and/or inner envelope is preferably high strength, typically 5000 denier, 7 grams per denier polypropylene. It is noted that use of stitching can be usefully employed other than for the purpose of sealing. For example, if stitching is used at comers and along edges of a unit regardless of whether this is required for sealing the stitching also selves a protective function. This function may be enhanced by judicious choice of the stitch type; overlock chain stitch is preferred. The stitching also provides a stiffening function so that the filled unit adopts a parallelepiped form

In one embodiment there are two inner envelopes having respective rectangular end panels matching those of the outer casing. Each inner envelope comprises a tubular element with the said rectangular end panel at one end and a linear closure at the other end to form a tapered generally wedge-shape container. The inner envelopes are positioned with their narrow ends overlapping.

The present invention also provides a protective surface comprising a plurality of units as described above.

Various embodiments of the present invention will now be more particularly described, by way of example, with reference to the accompanying drawings, in which:

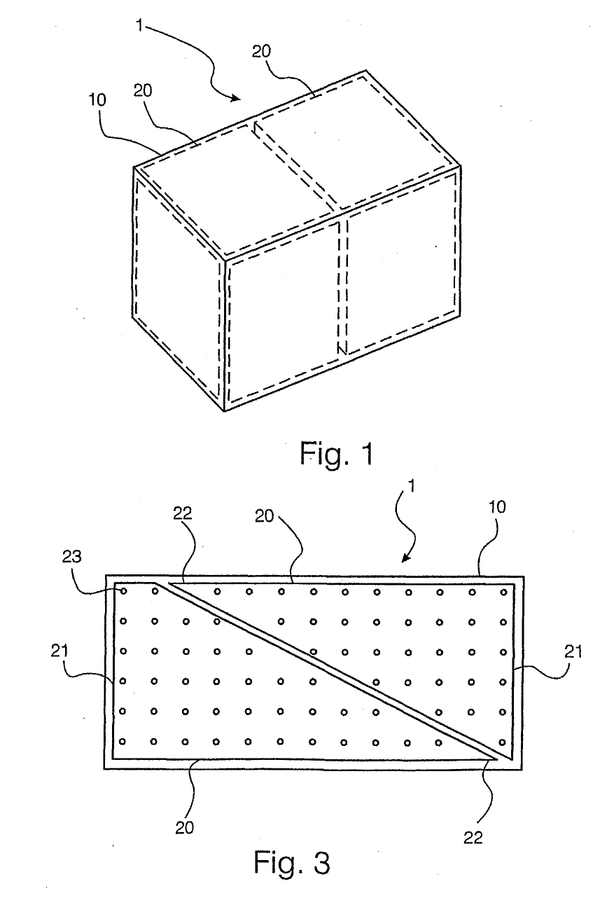

FIG. 1 is a perspective view of an impact-absorbing unit according to an embodiment of the present invention;

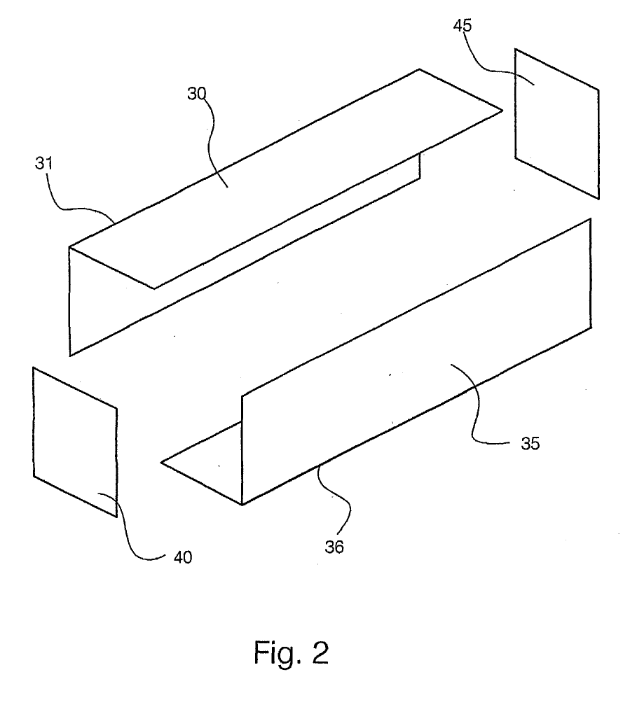

FIG. 2 is an exploded view of the constituent parts of an outer casing;

FIG. 3 is a schematic side view of an alternative embodiment;

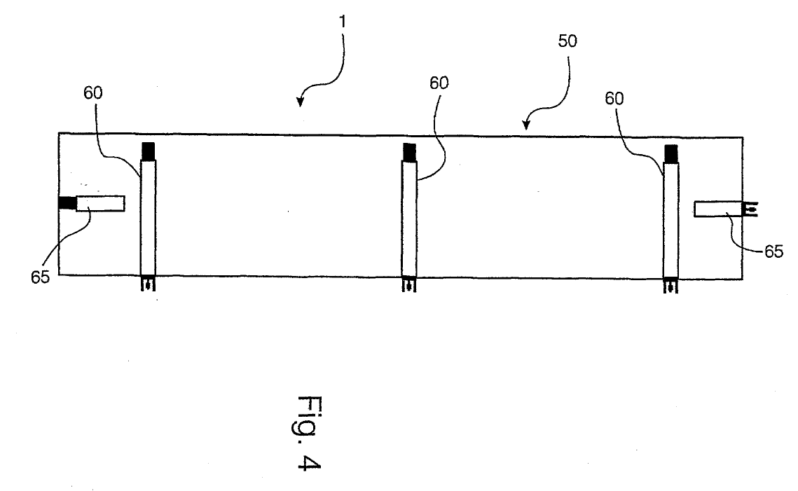

FIG. 4 is a plan view of a unit according to a preferred embodiment;

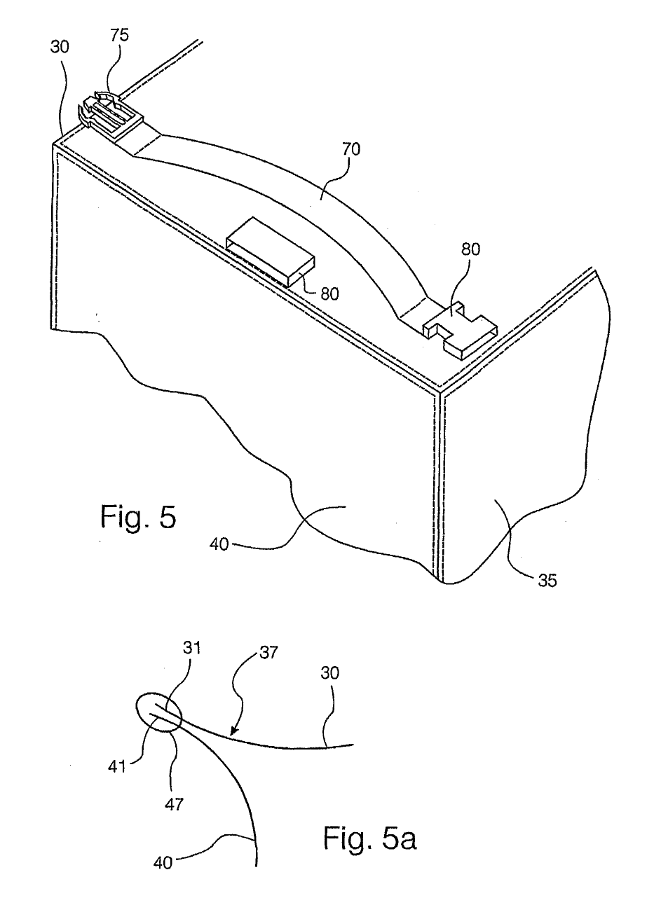

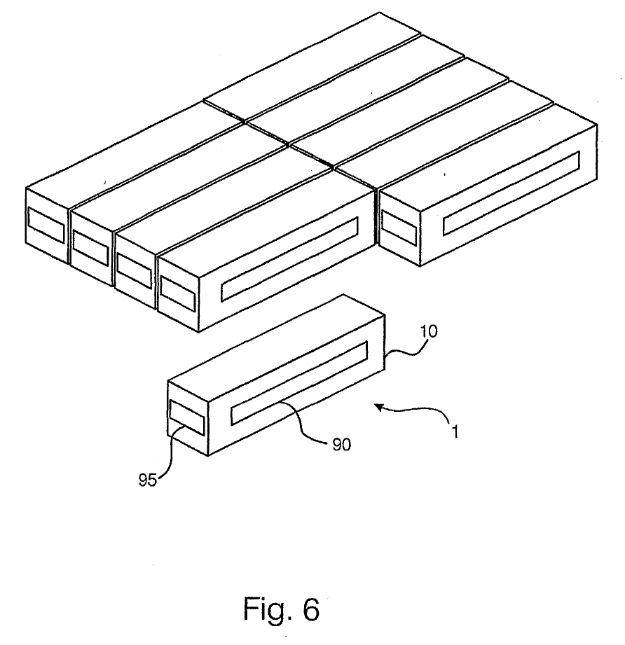

FIG. 5 is a perspective view of an end of the unit shown in FIG. 4;

FIG. 5a is a magnified view of the unit shown in FIG. 5 in the region of a join between two panels

FIG. 6 is a perspective view of a surface formed from the interconnection of a plurality of impact-absorbing units;

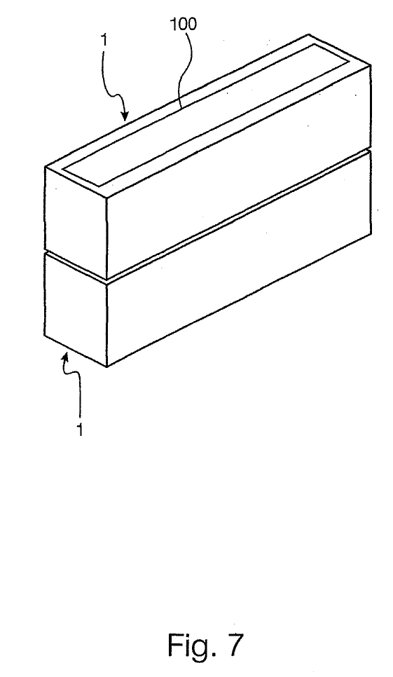

FIG. 7 is a perspective view of an alternative embodiment in which units can be securely stacked one on top of the other; and,

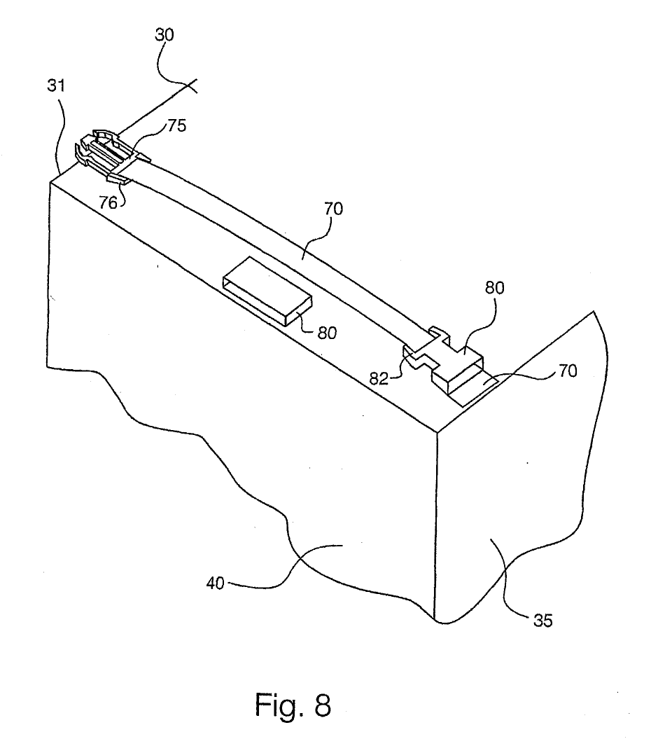

FIG. 8 is a view similar to that of FIG. 5 but of an alternative embodiment.

Referring first to FIG. 1 there is shown an impact-absorbing unit generally indicated 1. The unit 1 comprises an outer casing 10 and two inner envelopes 20. The outer casing 10 is formed from a wear resistant material; the inner envelopes are formed from stress-resistant material. Other properties of the casing 10 and envelopes 20 may be seen as preferable. For example, water-resistance or fire-resistance may be preferred or required depending on the conditions in which the unit 1 will be used. The inner envelopes 20 contain a loose fill of compressible particles (not shown) which dissipate energy upon impact. In a preferred embodiment expanded polystyrene particles are used with a fill density in the region of 1.85 to 1.90 kg per cubic metre of inner envelope. The particles may be in the form of a “Figure of 8” or S-shaped. In this embodiment the outer casing 10 is formed from woven polypropylene; the inner envelope is formed from 50 micron thick polypropylene. Typical dimensions for the unit are 2.5 m×56 cm×56 cm. The outer casing is preferably 1650-1800 Denier woven polypropylene having a tensile strength of 1.7 MNm⁻² and weight of about 0.1 KGm⁻². The weight of the filled unit is preferably less than 7 kg.

Referring now also to FIG. 2, the outer casing 10 is formed from two major panels 30,35 and two rectangular end panels 40,45 the panels are cut from a continuous sheet using a heat cutter. Panels 30,35,40,45 are first joined to form an open sided enclosure before inner envelopes 20 are inserted laterally and the opening is then closed by stitching the remaining edge between panels 30 and 35. Alternatively, panels 30,35 and 40 are first joined to form an open-ended sack, before inner envelopes 20 are inserted and rectangular end panel 45 is used to close the casing 10. The panels 30,35,40,45 are joined by stitching along adjacent edges (see FIG. 5a). In other embodiments the panels 30 and 35 are also stitched along their respective longitudinal fold lines 31 and 36 to form projecting ridges.

One possible orientation of the inner envelopes 20 is shown in FIG. 3, in which the inner envelopes 20 are generally wedge-shape elements having rectangular end panels 21 which match the panels of the outer casing 10 and taper to a linear closure 22. The envelopes are positioned within the outer casing 10 so that the narrow ends of the envelopes 20 overlap. This helps to maintain the shape of the unit as a whole. Each envelope 20 has vertical rows of perforations 23 in the form of circular holes approximately 6 mm in diameter. The perforations 23 allow air to pass through the envelope, particularly during an impact.

Referring now to FIGS. 4 and 5 there is shown a top surface 50 of the unit 1. The surface 50 has three lateral interconnection modules 60 spaced along its length and a longitudinal interconnection module 65 at either end there of. The lateral interconnection modules 60 comprise a lateral strap 70 secured at either end by stitching and attached at each end to a male 75 or female 80 portion of a clasp fastener. The strap is loose between each end to form a handle for manipulating the unit 1.

The longitudinal interconnection module 65 comprises a female 80 portion of a clasp buckle type fastener. In some embodiments at each connection point both a male and female portion is provided so that the orientation of units with respect to each other is not important for interconnection purposes.

The lateral 60 and longitudinal 65 modules allow interconnection of units 1 to form a substantially continuous surface. The unit 1 is of substantially even section along its length so that a surface formed is substantially planar.

FIG. 5a is a magnified view of the region of the join between panels. Where the edges of the panels meet they are pressed together to form two lips 31, 41 and stitched over the join; a chain overlock stitch 47 is preferred. This type of stitching is preferred because later stitches serve to secure earlier stitches which results in a strong join. In this way a rigid upstanding rib 37 is formed at the periphery of the panels 30, 40 and along the longitudinal edges of the panels 30 and 358, which helps to maintain the shape of the unit 1. If the stitches 47 are close together the result is a substantially continuous sheath which helps to protect the most vulnerable part of the unit. This principle can be employed equally as well for the inner envelopes 20.

FIG. 6 shows a protective surface formed from the interconnection of a plurality of units 1. In this embodiment the interconnection means comprise longitudinal and lateral hook and loop fastener panels 90,95 attached to adjacent panels of the outer casing.

In FIG. 7 hook and loop fastener panels 100 are provided on upper and lower surfaces of units 1, to allow the units to be securely stacked. In this way a multi-layered surface could be constructed.

Referring to FIG. 8, in an alternative arrangement for that of FIG. 5, the strap 70 of the lateral interconnection modules 60 is secured at either end by stitching the strap along or adjacent to the respective longitudinal edges of the panels 30, 35. The male and female connectors 75 and 80 are threaded on the strap 70 through respective aperture eyelets 76, 82 which allows movement of the connectors along the strap.

The invention also contemplates embodiments where the inner envelopes 10 are deleted and the outer casing 10 is filled directly with compressible particles. In other embodiments the compressible particles are replaced by an open cell foam structure. The foam can be used to fill the outer casing 10 with or without inner envelopes 20. In preferred embodiments the open cell foam is sealed within an airtight envelope, provided by the outer casing 10 or inner envelopes 20, with valve means to allow compression of the foam by suction and decompression thereof by subsequent exposure to ambient air pressure.

Although aspects of the invention have been described with reference to the embodiments shown in the accompanying drawings it is to be understood that the invention is not limited to those precise embodiments and various changes and modifications may be effected without exercise of further inventive skill and effort.

1. An impact-absorbing unit comprising an outer wear-resistant casing and one or a plurality of inner stress resistant envelopes containing impact absorbing material, the outer envelope being provided with interconnection means associated with at least one surface thereof whereby a plurality of such units can be connected together in a closely adjacent relationship to define a substantially continuous surface.

2. An impact-absorbing unit as claimed in claim 1, in which the said impact absorbing material is compressible.

3. An impact-absorbing unit as claimed in claim 1 or claim 2, in which the said impact-absorbing material is such as to dissipate impact energy.

4. An impact-absorbing unit as claimed in any claim 1 to 3, in which the said impact-absorbing material comprises a loose fill of substantially compressible granules.

5. An impact-absorbing unit as claimed in any of claims 1 to 4, in which the or each said inner envelope is perforated to allow the passage of air therethrough.

6. An impact-absorbing unit as claimed in any preceding claim, in which the said interconnection means comprise a clasp or the like

7. An impact-absorbing unit as claimed in any preceding claim, in which the said interconnection means are arranged to allow interconnection of adjacent upper and lower surfaces of respective units whereby to allow stacking of units to increase the absorbent capacity of the said substantially continuous surface.

8. An impact-absorbing unit as claimed in any preceding claim, further comprising a handle portion.

9. An impact-absorbing unit as claimed in any of claims 6 to 8, in which the said clasps or the like are positioned at the free ends of external straps secured to the outer casing at each end to form handles.

10. An impact-absorbing unit as claimed in any preceding claim, in which the fill density of impact-absorbing material is in the region of 1.85 to 1.90 kg per 0.425 cubic metres of inner envelope.

11. An impact-absorbing unit comprising an outer wear-resistant casing, a closed inner stress resistant envelope containing a plurality of compressible elements loosely enclosed within it, the said outer wear-resistant casing comprising a plurality of substantially planar flexible panels secured together in such a way as to maintain an external form having at least one substantially flat surface to allow a plurality of such units to be placed adjacent one another with the said at least one surfaces of each unit lying substantially in a common plane whereby to define an overall surface for receiving falling objects.

12. An impact-absorbing unit as claimed in claim 11, which unit is of generally parallelepiped form.

13. An impact-absorbing unit as claimed in claim 12, in which the said unit is formed from two major panels each defining two adjacent major surfaces of the parallelepiped, and two rectangular end panels.

14. An impact-absorbing unit as claimed in claim 13, in which the said panels are secured edge to edge to form a protective ridge.

15. An impact-absorbing unit as claimed in claim 12 or claim 13, in which the said panels are secured together by stitching.

16. An impact-absorbing unit as claimed in any of claims 13 to 15, in which there are two inner envelopes having respective rectangular end panels matching those of the outer casing.

17. An impact-absorbing unit as claimed in claim 16, in which each inner envelope comprises a tubular element with the said rectangular end panel at one end and a linear closure at the other end to form a tapered generally wedge-shape container.

18. An impact-absorbing unit as claimed in claim 17, in which the said inner envelopes are positioned with their narrow ends overlapping.

19. An impact-absorbing unit comprising an outer wear-resistant casing containing a plurality of compressible elements loosely enclosed within it, the said outer wear-resistant casing comprising a plurality of substantially planar flexible panels secured together in such a way as to maintain an external form having at least one substantially flat surface to allow a plurality of such units to be placed adjacent one another with the said at least one surfaces of each unit lying substantially in a common plane whereby to define an overall surface for receiving falling objects.

20. An impact-absorbing unit comprising an outer wear-resistant casing, at least one closed inner stress-resistant air-tight envelope containing at least one compressible foam element within the said envelope, and valve means for evacuating air from the said envelope compressing the said foam, the said outer wear-resistant casing comprising a plurality of substantially planar flexible panels secured together in such a way as to maintain an external form having at least one substantially flat surface, when the said foam element is expanded, to allow a plurality of such units to be placed adjacent one another with the said at least one surfaces of each unit lying substantially in a common plane whereby to define an overall surface for receiving falling objects.

21. A protective surface comprising a plurality of units according to any preceding claim.
